(19) United States
(12) Patent Application Publication
(10) Pub. No.: US 2011/0254689 A1
(43) Pub. Date: Oct. 20, 2011

(54) DOOR ALARM AND METHOD OF USE

(76) Inventor: Carl Snyder, Roy, UT (US)

(21) Appl. No.: 12/759,708

(22) Filed: Apr. 14, 2010

(51) Int. Cl. G08B 13/08

(52) U.S. Cl. 340/545.5; 340/546

(57) ABSTRACT

The present invention relates generally to a personal door alarm and more specifically to a battery powered door alarm that can be easily transported from location to location, can be installed on most door knob assemblies and is simple to deploy. The personal door alarm provides protection for valuable property and to the occupants of the habitation.

### SUMMARY OF THE INVENTION

The present invention relates generally to a personal door alarm and more specifically to a battery powered door alarm that can be easily transported from location to location, can be installed on most door knob assemblies and is simple to deploy. The personal door alarm provides protection for valuable property and to the occupants of the habitation.

While there are door alarm systems available, most have significant limitations, including requiring permanent installation, require tools for installation, do not transport readily, require the door or entry to be completely breached before activation, or are not sensitive to movement of the door knob.

Commonly known in the art are door sensor and alarm systems that include magnetic contacts that can be armed when the corresponding magnets or a magnet and metallic contact are in close proximity. The alarm unit is typically mounted on the interior door surface with the corresponding contact mounted adjacent to the alarm unit on the door frame or moulding. This is a permanent installation, where the door and moulding must be drilled and the alarm and contact are fastened to surfaces, typically using screws. The method of mounting permanently alters the door surface, leaving the drill holes and marks if the alarm is removed. Door alarms using magnetic contacts also require that the door is at least partially ajar before the contact is broken and the alarm is actuated. Once, the principle door lock and mechanism have been overcome and the door is partially ajar, an intruder may have access to the alarm itself and can disable it, or if the intruder has intent to do harm to the occupants, they may chose to ignore the alarm and proceed into the room. Another limitation or this type of alarm is the lack of portability, if the user desires to move the alarm to a new location they would have to remove the screws and re-install the alarm on a different door.

Also commonly known in the art, are other portable alarms designed to detect vibration if the door is impacted or if an intruder tries to force the door open. The alarm is typically actuated using a mercury motion switch, where a mercury globule in encased in a sealed glass basin or tube having intruding electrical contacts, when the mercury is sufficiently disturbed it will deform or move into a position to complete the circuit and set off the alarm. These alarms lack the sensitivity to detect subtle movements of a door knob if an intruder is carefully checking to see if a door is unlocked or unsecure. The mercury used in the devices also presents an environmental hazard once the alarm is no longer in service.

What is needed is a personal door alarm that is easy to install, does not damage a door when installed, is portable, will activate prior to the door being breached, is sufficiently sensitive to detect subtle movements of a door knob and does not contain mercury.

The present invention is a personal door alarm that does not require permanent attachment, does not damage the door, can simply be placed on a door knob or handle of most doors, can be easily moved from door to door, will activate when the door knob or handle is moved only slightly and does not contain any toxic mercury. The personal door alarm can be used for home security, on an apartment, condominium, for safety during travel, such as, a hotel room door or restroom, on an office door, or to protect personal property or tools on a job site or prevent entry into a shed or storage locker.

A first embodiment of the present invention includes a housing, alarm circuitry, and attachment mechanism. The housing may be formed using a thermoplastic, such as nylon, polyethylene, ABS or a blend of such materials. It contemplated that the housing may also be a cast material or formed using a sheet material such as aluminum. The housing is such a size as to enclose the alarm mechanism and power supply. In one embodiment, the housing is approximately the size of a deck of playing cards, or 2 by 3 inches, having a thickness of one inch. It is understood and contemplated that the size may be reduced to improve portability.

The alarm circuitry is a reliable simple circuit having two biased tilt switches, a relay, siren or alarm, master switch and power supply. In one embodiment the tilt switches are in fixed positions from a vertical axis, wherein, the first switch is open when the personal door alarm is in a vertical position and closes when the alarm is tilted to the right. The second tilt switch is open when the personal door alarm is in a vertical position and closes when the alarm is tilted to the left. When either tilt switch closes the relay is activated and remains energized, with the siren sounding, until the master switch is turned off. In one embodiment, the alarm is activated when the housing is displaced, left or right, two (2) degrees from a vertical position. In one embodiment, the alarm is activated when the housing is displaced, left or right, three (3) degrees from a vertical position. In one embodiment, the alarm is activated when the housing is displaced, left or right, four (4) degrees from a vertical position. In one embodiment, the alarm is activated when the housing is displaced, left or right, five (5) degrees from a vertical position. In one embodiment, the alarm is activated when the housing is displaced, left or right, six (6) degrees from a vertical position. In one embodiment, the alarm is activated when the housing is displaced, left or right, seven (7) degrees from a vertical position. In one embodiment, the alarm is activated when the housing is displaced, left or right, eight (8) degrees from a vertical position. In one embodiment, the alarm is activated when the housing is displaced, left or right, nine (9) degrees from a vertical position. In another embodiment, the alarm is activated when the housing is displaced, left or right, ten (10) degrees or greater, from the vertical position. The alarm will activate if the housing is tilted away from the door or if the housing is dislodged from the door handle or knob. Embodiments, wherein the sensitivity of the alarm is adjusted, by such means as knobs or screws, changing the orientation of the tilt switches relative to the vertical axis of the housing are also contemplated. The siren is such that it provides an adequate volume to alert occupants of a room or habitation of an intrusion attempt, the siren will be heard over ambient noise within habitations and most work situations, including television, music, or conversations. In one embodiment, the siren has a volume between 85 and 115 decibels. Power supply is alkaline, lithium ion disposable or rechargeable batteries. The alarm will not activate until the master switch is in the “on” or closed position and the power supply will not drain unless the holding circuit is closed and the alarm is tripped or one of the tilt switches is closed. The siren will sound and the holding circuit will stay closed until the master switch is moved to the open position or the personal door alarm is turned off using the master switch. It is contemplated that the holding circuit may also include a timed relay that shuts of the siren after a specified time.

In one embodiment, the attachment mechanism is configured to attached to spherical, cylindrical, or frustoconical door handles or knobs. In one embodiment, the attachment mechanism is configured to attach to lever or rod type door handles. In one embodiment, the attachment mechanism is configured to be adjustable to attach to a variety of door handle or knob configurations.

In case of emergency egress, the attachment mechanism allows for easy removal of the personal door alarm or for direct actuation of the door handle with the alarm in place.

### BRIEF DESCRIPTION OF DRAWINGS

FIG. 1—Embodiment of a personal door alarm.

FIG. 2—Schematic view of a personal door alarm.

FIG. 3—Embodiment of a personal door alarm in place.

### DETAILED DESCRIPTION OF THE INVENTION

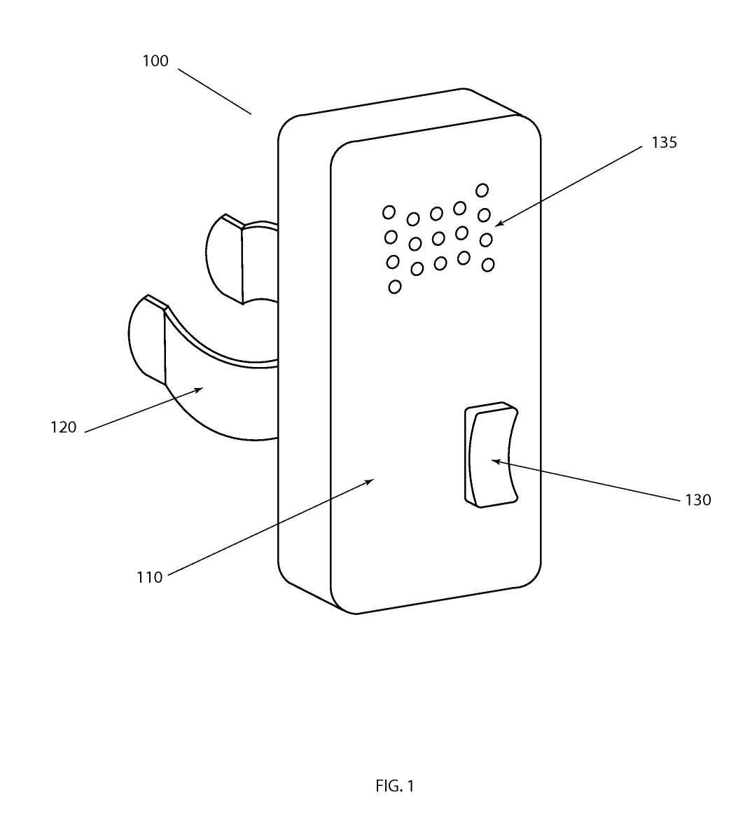

In one embodiment, personal door alarm 100, in FIG. 1, includes housing 110, attachment mechanism 120 and electrical circuitry, including visible master switch 130 and siren 136. Housing 110 may be formed from a thermoplastic, such as ABS, polyester, nylon or a blend of such materials. Housing 110 is such size as to provide reasonable portability and encase the electrical circuitry, it recognized that configuration of housing 110 can vary and may be formed in almost any shape to allow the alarm to be less conspicuous when installed or to include ornamental elements, making the alarm part of the dècor.

In one embodiment, attachment mechanism 120 is configured to attach to spherical, cylindrical or frustoconical door handles or knobs. In another embodiment, attachment mechanism 120 is configured to attach securely to lever or rod type door handles. In another embodiment, attachment mechanism 120 is adjustable and may be configured or adapted to fit a variety of door handles or knobs. In yet another embodiment, attachment mechanism 120 is interchangeable. Attachment mechanism 120 may be formed using a resilient plastic such as ABS or nylon or may be steel or spring steel. If attachment mechanism 120 is formed using metal, is desirable to include a coating, such as rubber, to protect the finish of the door handle or knob.

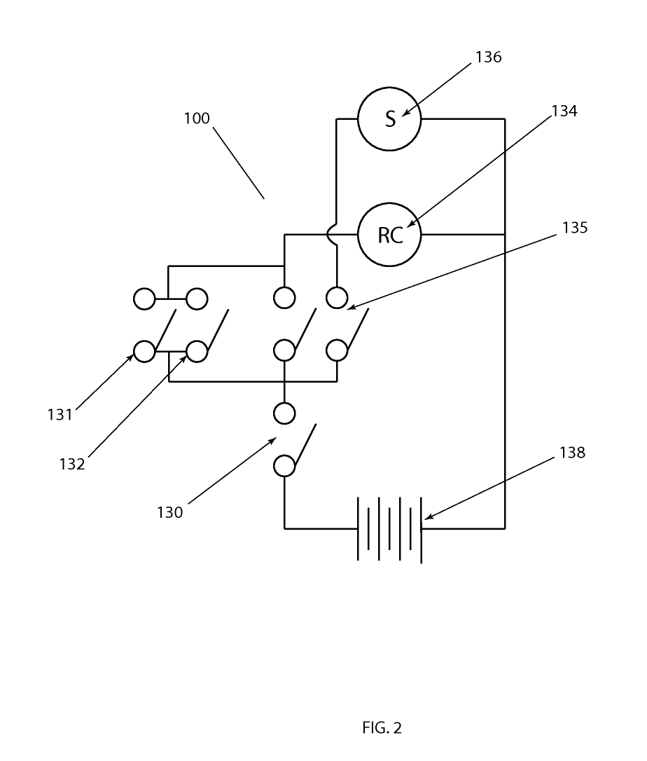

In one embodiment, the electronic circuitry for personal door alarm 100 includes master switch 130 and siren 136, as shown in FIG. 1. FIG. 2 is a schematic layout of the basic electrical components of personal door alarm 100, including master switch 130, left tilt switch 131, right tilt switch 132, relay coil 134, relay contacts 135, siren 136 and battery 138. In one embodiment, the left tilt switch 131 and right tilt switch 132 are the encapsulated conductive metal bearing or ball type and are in a fixed position, approximately 3 to 5 degrees from the vertical axis of the personal door alarm 100. In one embodiment, the left tilt switch 131 and right tilt switch 132 are independently adjustable using a screw or knob. This will allow a user to adjust the sensitivity of the personal door alarm 100. Relay assembly including, relay coil 134 and relay switches 135, is a double pole, double throw configuration. Relay coil 134 and relay switches 135 are normally open and will only close or actuate when energized after one of left tilt switch 131 or right tilt switch 132 is closed. The relay coil 134 will remain closed and siren 136 will sound until master switch 130 is opened or the personal door alarm is turned off using master switch 130 and the system is reset. The siren 136 has such volume to alert occupants of intrusion over typical ambient noise and warn off any intruder, volume of siren 136 is between 85 and 115 decibels. In one embodiment, power is supplied using battery 138, battery 138 may be a alkaline 9 volt, sizes C, D, AA, AAA or other battery types, or may be rechargeable in any available size depending upon configuration and electrical demands.

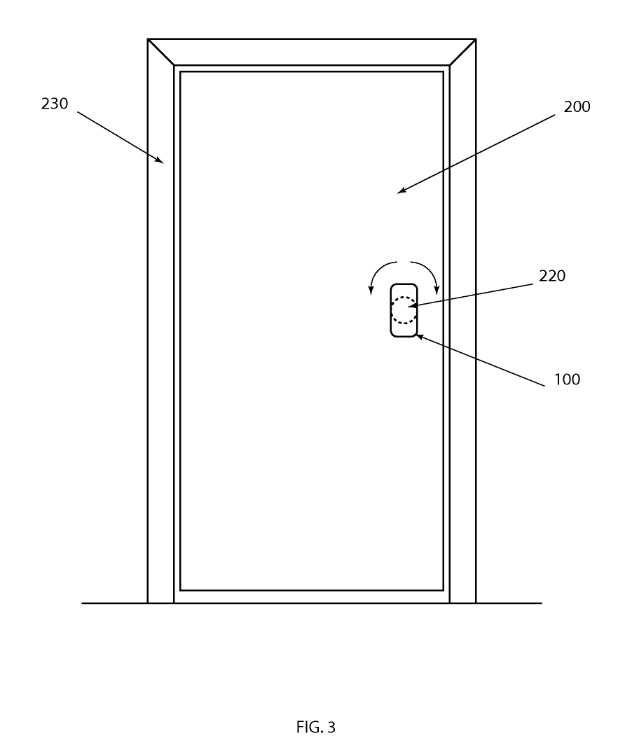

Personal door alarm 100 is installed on door 200 in FIG. 3. A user desiring notification of intrusion or desiring personal protection may install personal door alarm on most any door 200 having a rotationally actuated handle or door knob 220. This may include a home, apartment, condominium, office, hotel room, restroom or a myriad of other rooms. The user will fasten or position the personal door alarm 100 over the door knob 220, by pressing or slipping attachment mechanism 120 (FIG. 1) over door knob 220 and aligning the personal door alarm in a vertical position. The user will then activate personal door alarm 100 by turning on or closing master switch 130. The siren 136 of personal door alarm 100 will not sound until personal door alarm 100 has been moved from a vertical position, if an intruder moves the door knob 220 left in excess of the open position of left tilt switch 131, left tilt switch 131 will close, relay 134 will close and siren 136 will sound, the siren will continue to sound until the personal door alarm 100 is turned off or master switch 130 is opened. If an intruder moves door knob 220 to the right, the same process will occur, with the right tilt switch 132 closing and the siren 136 will sound. Personal door alarm 100 is removably attached to a door knob or handle 220 only, and does not require any permanent attachment to door 200 or door frame 230.

It will be obvious to those having skill in the art that many changes may be made to the details of the above-described embodiments without departing from the underlying principles of the invention. The scope of the present invention should, therefore, be determined only by the following claims.

1. A personal door alarm comprising;
a housing,
an attachment mechanism that removably attaches the personal door alarm to a door knob in a fixed position and,
an electronic alarm.

2. The personal door alarm of claim 1, wherein the attachment mechanism is configured for a spherical, cylindrical and a frustoconical door knob.

3. The personal door alarm of claim 1, wherein the attachment mechanism is configured for a lever door handle.

4. The personal door alarm of claim 1, wherein the attachment mechanism is adjustable.

5. The personal door alarm of claim 1, wherein the electronic alarm includes at least one tilt switch.

6. The personal door alarm of claim 5, wherein the at least one tilt switch is in a fixed position.

7. The personal door alarm of claim 5, wherein the at least one tilt switch is adjustable.

8. A method for using a personal door alarm comprising:
removably attaching the personal door alarm to a door knob in a fixed position,
activating the door alarm,
triggering door alarm by turning door knob to the left or to the right and,
deactivating the door alarm.
